(19) United States
(12) Patent Application Publication
(10) Pub. No.: US 2022/0204035 A1
(43) Pub. Date: Jun. 30, 2022

(54) DRIVER MANAGEMENT SYSTEM AND METHOD OF OPERATING SAME

(71) Applicant: HYUNDAI MOBIS Co., Ltd., Seoul (KR)

(72) Inventor: Douglas C. MacKenzie, Livonia, MI (US)

(21) Appl. No.: 17/135,367

(22) Filed: Dec. 28, 2020

(51) Int. Cl. B60W 60/00; B60W 40/08; B60W 50/14

(52) U.S. Cl. CPC B60W 60/0015; B60W 40/08; B60W 50/14; B60W 60/0051; B60W 60/0059; B60W 2050/146; B60W 2420/54; B60W 2540/225; B60W 2540/227; B60W 2040/0809; B60W 2420/40

(57) ABSTRACT

A driver management system, method, and computer readable medium capable of operating the same. The driver management system includes: a monitoring part configured to determine a level of driving attention of a driver of a vehicle; and a driving guide part configured to receive the level of driving attention from the monitoring part, determine a level of necessary attention required according to an autonomous driving level of a vehicle, and provide the driver with information on the level of necessary attention such that the level of driving attention satisfies the level of necessary attention.

### BACKGROUND

### Field

Exemplary embodiments relate to a driver management system and a method of operating the same, wherein the driver management system determines a level of driving attention of a vehicle driver and provides the driver with information on a level of necessary attention required according to an autonomous driving level, and when the level of driving attention satisfies the level of necessary attention, an autonomous driving function of a vehicle is operated.

### Discussion of the Background

Recently, in autonomous driving of a vehicle, an issue about how and to what extent a driver's driving intervention is performed in accordance with the autonomous vehicle has been raised. In this regard, the Society of Automotive Engineers (SAE) has defined autonomous driving levels of a vehicle, as a total of six levels, from level 0 without autonomous driving to level 5 for fully autonomous vehicles. The levels to which a vehicle driver and a system intervene in the driving of the vehicle differ for each level.

At this time, since a level to which a driver and a system of a vehicle intervenes in driving of the vehicle is different for each level, when an autonomous driving function is performed while the vehicle is driving, the autonomous driving function according to an autonomous driving level may be performed only when the driver takes actions appropriate to the corresponding autonomous driving level. Whereas, when the autonomous driving function is performed while the driver does not take actions appropriate to the autonomous driving level, there exists a risk of accidents.

Therefore, there is a need to develop a driver management system that monitors a driver to determine whether a driver's behavior required for each autonomous driving level is satisfied, guides the driver with necessary driver actions, and performs the autonomous driving function when the driver's behavior satisfies the behavior required for the autonomous driving level.

The above descriptions as background arts are only for improving the understanding of the background of the present invention, and should not be accepted as acknowledging that they correspond to the related arts already known to those skilled in the art.

The above information disclosed in this Background section is only for enhancement of understanding of the background of the invention and, therefore, it may contain information that does not constitute prior art.

### SUMMARY

Exemplary embodiments of the present invention provide a driver management system and a method of operating the same, wherein the driver management system determines a level of driving attention of a vehicle driver to determine a level of necessary attention required according to an autonomous driving level of a vehicle, provides the driver with information on the level of necessary attention required according to the autonomous driving level, and performs an autonomous driving function of the vehicle when the level of driving attention satisfies the level of necessary attention.

Additional features of the invention will be set forth in the description which follows, and in part will be apparent from the description, or may be learned by practice of the invention.

A driver management system according to an embodiment includes: a monitoring part configured to determine a level of driving attention of a driver of a vehicle; and a driving guide part configured to receive the level of driving attention from the monitoring part, determine a level of necessary attention required according to an autonomous driving level of a vehicle, and provide the driver with information on the level of necessary attention such that the level of driving attention satisfies the level of necessary attention.

The monitoring part may collect status information on a state of the vehicle or the driver through a sensor provided in the vehicle, and may determine the level of driving attention of the driver through the status information.

The sensor may include a camera, a biometric sensor, a sound sensor, a motion sensor, or a contact sensor, and may be operated toward the vehicle or the driver from a position inside or outside the vehicle.

The status information may include a driver's gaze, whether a driver's hand is positioned on a steering wheel, or a driver's seat position.

The monitoring part may determine that the level of driving attention of the driver is high when the driver's gaze is directed forward, or when the driver's hand is positioned on the steering wheel, or when the driver's seat position is close to vehicle's acceleration and deceleration devices, and may determine that the level of driving attention of the driver is low when the driver's gaze is directed from a front point to other points not directed to the front of the vehicle, or when the driver's hand is not positioned on the steering wheel, or when the driver's seat position is not close to the vehicle's acceleration and deceleration devices.

The driver management system may further include an autonomous driving part for controlling an autonomous driving function of the vehicle, wherein the autonomous driving part may receive the level of driving attention and the level of necessary attention from the monitoring part and the driving guide part, respectively.

The autonomous driving part may perform the autonomous driving function of the vehicle according to a required autonomous driving level when the level of driving attention of the driver satisfies the level of necessary attention required according to the required autonomous driving level.

The driving guide part may warn the driver or reinform the driver with the information on the level of necessary attention when the level of driving attention of the driver does not satisfy the level of necessary attention required according to the required autonomous driving level.

The driving guide part may warn the driver or reinform the driver with the information on the level of necessary attention in a manner including a warning light, a voice, or a display inside the vehicle.

When the level of driving attention of the driver is changed, the driving guide part may update the autonomous driving level required according to the changed level of driving attention.

A method of operating a driver management system according to an embodiment includes: monitoring a driver of a vehicle to determine a level of driving attention of the driver; determining a level of necessary attention required according to a required autonomous driving level; and guiding the driver by providing information on the level of necessary attention to the driver such that the level of driving attention determined in the monitoring of the level of driving attention of the driver satisfies the level of necessary attention.

The method of operating the driver management system may further include: after the guiding the driver, performing an autonomous driving function of a vehicle, wherein the autonomous driving function of the vehicle according to the required autonomous driving level is performed when the level of driving attention determined in the monitoring of the level of driving attention of the driver satisfies the level of necessary attention.

The method of operating the driver management system may further include: after the guiding the driver, reinforming the driver, wherein the driver is warned or reinformed with the information on the level of necessary attention when the level of driving attention determined in the monitoring of the level of driving attention of the driver does not satisfy the level of necessary attention.

The method of operating the driver management system may further include, when the level of driving attention of the driver is changed after the guiding the driver, updating the autonomous driving level to update the autonomous driving level required according to the changed level of driving attention.

According to the driver management system and the method of operating the same of exemplary embodiments, the driver management system determines the level of driving attention of the vehicle driver to determine the level of necessary attention required according to the autonomous driving level of the vehicle, provides the driver with the information on the level of necessary attention required according to the autonomous driving level, and performs the autonomous driving function of the vehicle when the level of driving attention satisfies the level of necessary attention.

In another exemplary embodiment, a non-transitory computer readable program medium includes program code, that when executed by at least one processor, causes the at least one processor to perform operations including: receiving, from a sensor, monitoring information of a driver of a vehicle to determine a level of driving attention of the driver; determining a level of necessary attention required according to a required autonomous driving level; and assisting the driver by providing information on the level of necessary attention to the driver such that the level of driving attention determined in the monitoring of the level of driving attention of the driver satisfies the level of necessary attention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a view showing a driver management system according to an exemplary embodiment.

FIG. 2 is a view showing a flowchart of a method of operating the driver management system according to the exemplary embodiment.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this description is thorough, and will fully convey the scope of the invention to those skilled in the art. Like reference numerals in the drawings denote like elements.

Various advantages and features of the present invention and methods accomplishing thereof will become apparent from the following description of embodiments with reference to the accompanying drawings. However, the present invention is not be limited to the embodiments set forth herein but may be implemented in many different forms. The present embodiments may be provided so that the disclosure of the present invention will be complete, and will fully convey the scope of the invention to those skilled in the art and therefore the present invention will be defined within the scope of claims. Like reference numerals throughout the description denote like elements.

Unless defined otherwise, it is to be understood that all the terms (including technical and scientific terms) used in the specification has the same meaning as those that are understood by those who skilled in the art. Further, the terms defined by the dictionary generally used should not be ideally or excessively formally defined unless clearly defined specifically. It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

As is customary in the field, some exemplary embodiments are described and illustrated in the accompanying drawings in terms of functional blocks, parts, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, parts, units, and/or modules without departing from the scope of the inventive concepts.

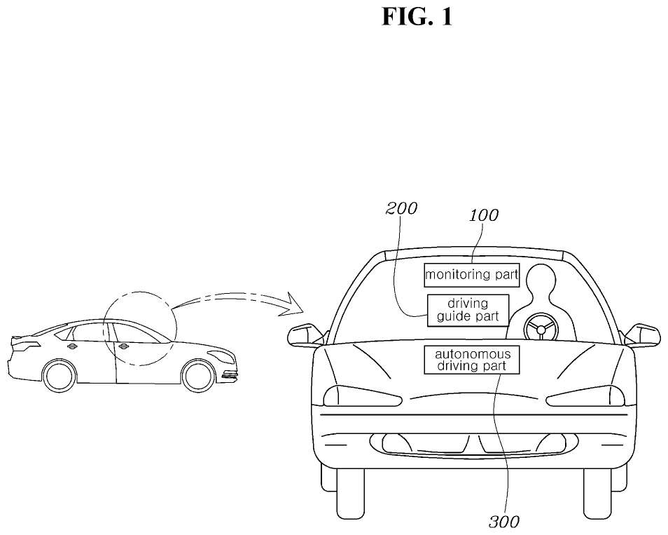

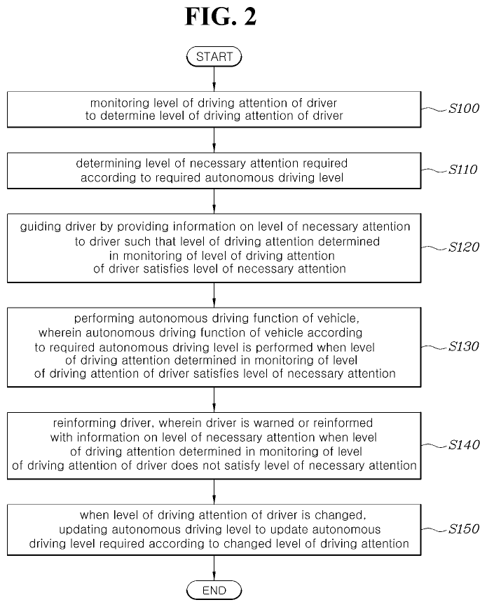

FIG. 1 is a view showing a driver management system according to an exemplary embodiment. FIG. 2 is a view showing a flowchart of a method of operating the driver management system according to the exemplary embodiment.

FIG. 1 shows the driver management system according to the exemplary embodiment. The driver management system according to the exemplary embodiment includes: a monitoring part 100 configured to determine a level of driving attention of a driver; and a driving guide part 200 configured to receive the level of driving attention from the monitoring part 100, determine a level of necessary attention required according to the autonomous driving level of a vehicle, and provide the driver with information on the level of necessary attention such that the level of driving attention satisfies the level of necessary attention.

The monitoring part 100, the driving guide part 200, or an autonomous driving part 300 according to the exemplary embodiment, may be implemented by applying a nonvolatile memory (not shown) configured to store data relating to an algorithm developed to control operations of various components of the vehicle or software instructions for reproducing the algorithm, and by applying a processor (not shown) configured to perform the operations described below by using data stored in the corresponding memory. As one example, the memory and the processor may be implemented as separate chips. Alternatively, the memory and the processor may also be implemented as a single chip integrated with each other, and the processor may also take a configuration having one or more processors.

Specifically, the autonomous driving level of a vehicle corresponds to six levels, including: level 0 in which a driver drives directly; level 1 in which the driver drives but a system assists in acceleration/deceleration or steering of the vehicle; level 2 in which the driver drives but the system assists in acceleration/deceleration and steering of the vehicle; level 3 in which the system drives but the driver immediately drives upon a system request; level 4 in which the system drives in specific situations and the driver does not intervene; and Level 5 in which the system drives in all situations. At this time, since the driver directly intervenes in driving from level 0 to level 2, there is no problem even when the autonomous driving function is limited. In the highly automated level of autonomous driving from level 4 or higher, driver's intervention is not required, but there are still many technical problems to be solved, and the realization cost is also very high.

However, in the case of autonomous driving level 3, since the driver's intervention is required at any time when the system requests, the level 3 autonomous driving function may be performed or the autonomous driving level may be changed to the level 3 only when the driver is ready to intervene in driving. Therefore, in the driver management system according to the exemplary embodiment, a driver is monitored through the monitoring part 100, thereby monitoring the level of driving attention to determine whether the driver is properly intervening in vehicle driving for each level of autonomous driving, or whether the driver is ready for driving intervention according to the corresponding autonomous driving level when the autonomous driving function is required. In this regard, the driving guide part 200 determines a level of necessary attention of a driver in driving according to each autonomous driving level, and only when the level of driving attention satisfies the level of necessary attention according to each autonomous driving level, the driving guide part 200 operates the autonomous driving function according to the autonomous driving level or changes the autonomous driving level, and thus accidents may be prevented and the vehicle may safely arrive at its destination by using the autonomous driving function.

Meanwhile, in the driver management system according to the exemplary embodiment, the monitoring part 100 collects status information on a state of a vehicle or a driver through a sensor provided in or on the vehicle, and a level of driving attention of the driver may be determined through the status information. The sensed data may be provided from the sensor to the monitoring part 100 by either wired or wireless communications, or both.

For example, the monitoring part 100 may use DDREM (Departed Driver Rescue and Exit Maneuver) technology, in which when a driver is unable to drive normally due to such as drowsy driving or cardiac arrest, a vehicle determines a driver's condition and automatically moves and stops at a safe place such as a road side.

DDREM technology is a system, in which when a vehicle moves in a zigzag manner due to driver's drowsiness, etc., or when a driver closes his or her eyes frequently without looking ahead, a sensor of DDREM detects this situation and leads the vehicle to the safe place technically, thereby meaning to rescue a driver who is unable to drive. DDREM technology uses two core technologies: a Driver Status Warning (DSW) system and a Driver Awareness warning (DAW) system. Through the sensor and DSW system that are provided in a vehicle, the monitoring part 100 may determine a driver's state, such as the driver's attention or whether the driver is drowsy, by determining driver's blinking patterns or by determining whether a driver's gaze is distracted, and through the sensor and DAW system, the monitoring part 100 may determine a vehicle's state, such as vibration of the vehicle (e.g., the vehicle has veered off a road and onto an irregular, non-smooth surface) or whether the vehicle crosses lanes. In this way, after collecting status information on the state of the vehicle or the driver, the monitoring part 100 determines a level of driving attention of the driver on the basis of the status information.

In addition, in the driver management system according to the exemplary embodiment, a sensor includes a camera, a biometric sensor, a sound sensor, a motion sensor, or contact sensor and may be operated toward a vehicle or a driver from a position inside or outside the vehicle. In the driver management system according to the exemplary embodiment, status information may include a driver's gaze, information on whether a driver's hand is positioned on a steering wheel, or a driver's seat position. In the case of autonomous driving levels 0 to 2, since the driver actively drives the vehicle, a driver's gaze may be directed forward, a driver's hand may be positioned on a steering wheel, and a driver's seat position may be positioned to be suitable for driving. However, in the case of autonomous driving level 3, in order to perform the autonomous driving function, since a driver should be able to operate the vehicle immediately upon request of the system, the level of driving attention should satisfy the level of necessary attention prepared according to the gaze, hand position, and seat position.

Meanwhile, in the driver management system according to the exemplary embodiment, the monitoring part 100 may determine that a level of driving attention of a driver is high when a driver's gaze is directed forward, or when a driver's hand is positioned on a steering wheel, or when a driver's seat position is close to vehicle's acceleration and deceleration devices, and may determine that the level of driving attention of the driver is low when the driver's gaze is directed from the front of the vehicle to another points not directed to the front of the vehicle, or when the driver's hand is not positioned on the steering wheel, or when the driver's seat position is not close to the vehicle's acceleration and deceleration devices.

Specifically, the level of driving attention may be classified into high, medium, low, etc., and the monitoring part 100 determines that the more a driver's gaze is toward the front, or the closer a driver's hand is to the steering wheel, or the closer a driver's seat position is to vehicle's acceleration and deceleration devices, the higher the level of driving attention of the driver is, and determines that the further the driver's gaze is from the front, or the further the driver's hand is to the steering wheel, or the further the driver's seat position is to vehicle's acceleration and deceleration devices, the lower the level of driving attention of the driver is.

In addition, the driving guide part 200 determines a level of necessary attention required for each autonomous driving level, and in the case of level 0 to level 2, since the driver directly drives the vehicle, the level of necessary attention should be at the high level, in which a driver's hand should always be positioned on a steering wheel, a driver's gaze should be directed forward and pay attention to the front, a driver's seat position should maintain a driver's sitting posture, a driver's foot should be in a suitable position so that an accelerator or deceleration pedal may be operated at any time, etc.

In the case of autonomous driving level 3, since the system directly drives the vehicle, the driver's hand does not need to be always positioned on the steering wheel, the driver's gaze also does not have to be directed forward, and the driver's seat position may be freely positioned to some extent. However, since the driver must be able to intervene in driving without delay within a predetermined period of time in a case where the system requests the driver to intervene in an unexpected situation, the driver must pay attention to the driving, and accordingly, the gaze, hand position, and seat position should not be excessively free to be in any position, and thus the level of necessary attention should be at the medium level.

In the case of autonomous driving level 4, since the driver's intervention is not required in a specific situation, and the driver's driving intervention is required only in an unexpected situation, the level of necessary attention is low, and in the case of autonomous driving level 5, since the driver's intervention is not required in all situations, the level of necessary attention is low as well.

Meanwhile, the driver management system according to the exemplary embodiment further includes an autonomous driving part 300 that controls an autonomous driving function of a vehicle, wherein the autonomous driving part 300 may receive the level of driving attention and the level of necessary attention from the monitoring part 100 and the driving guide part 200. The autonomous driving part 300 may perform the autonomous driving function of the vehicle according to the required autonomous driving level when the level of driving attention of a driver satisfies the level of necessary attention required according to the required autonomous driving level.

In addition, in the driver management system according to the exemplary embodiment, the driving guide part 200 may warn a driver or reinform the driver with information on the level of necessary attention when the level of driving attention of the driver does not satisfy the level of necessary attention required according to the required autonomous driving level. The driving guide part 200 may warn the driver or reinform the driver with information on the level of necessary attention in a manner including a warning light, a voice, or a display inside a vehicle.

Specifically, the driving guide part 200 determines the level of necessary attention and guides the driver about the level of necessary attention according to the required autonomous driving level, and for example, guides the driver with information such that the driver's gaze should be directed forward of the vehicle (e.g., in the direction the vehicle is moving), the driver's hand should be close to the steering wheel, or the seat position should be close to the acceleration/deceleration pedal. However, when the level of driving attention of a driver does not satisfy the level of necessary attention required according to the required autonomous driving level, the driving guide part 200 warns that the autonomous driving function according to the required autonomous driving level is unable to be performed, or warns the driver or reinforms the driver about an area where the level of driving attention does not satisfy the level of necessary attention.

Meanwhile, when the autonomous driving level is changed, the level of driving attention of a driver should satisfy the level of necessary attention required according to the changed autonomous driving level, but the driving guide part 200 requests the driver to intervene in driving by providing information on the level of necessary attention required according to the autonomous driving level which is to be changed. In addition, since sufficient time should be given to the driver to allow the level of driving attention to be changed when changing the autonomous driving level, the autonomous driving part 300 changes the autonomous driving level only when the level of driving attention of the driver is changed within a predetermined time and satisfies the level of necessary attention required according to the autonomous driving level which is to be changed. In particular, such a part described above is not a problem when the autonomous driving level is raised, but the importance is further increased when more intervention is required for the driver's driving due to lowering of the level of autonomous driving.

In addition, in the driver management system according to the exemplary embodiment, when the level of driving attention of the driver is changed, the driving guide part 200 may update the autonomous driving level required according to the changed level of driving attention. In this regard, in an unexpected situation, such as when a level of driving attention of a driver is lowered due to an urgent situation such as unconsciousness or drowsy driving, a warning or information is provided to the driver through the driving guide part 200, and the level of autonomous driving of the vehicle is increased under the determination of the driving guide part 200, whereby accidents may be prevented, and the vehicle may be controlled to drive to a place, such as a rest area or hospital, through the autonomous driving function.

FIG. 2 shows the flowchart of the method of operating the driver management system according to the exemplary embodiment. The method of operating the driver management system according to the exemplary embodiment: a step S100 of monitoring a level of driving attention of a driver to determine the level of driving attention of the driver; a step S110 of determining a level of necessary attention required according to a required autonomous driving level; and a step S120 of guiding the driver by providing information on the level of necessary attention to the driver such that the level of driving attention determined in the monitoring of the level of driving attention of the driver satisfies the level of necessary attention.

In addition, the method of operating the driver management system according to the exemplary embodiment further includes, after the guiding the driver S120, a step S130 of performing an autonomous driving function of the vehicle, wherein the autonomous driving function of the vehicle according to the required autonomous driving level is performed when the level of driving attention determined in the monitoring of the level of necessary attention of the driver S100 satisfies the level of necessary attention.

Additionally, the method of operating the driver management system according to the exemplary embodiment includes, after the guiding the driver S120, a step S140 of reinforming the driver, wherein the driver is warned or reinformed with information on the level of necessary attention when the level of driving attention determined in the monitoring of the level of necessary attention of the driver S100 does not satisfy the level of necessary attention.

Furthermore, the method of operating the driver management system according to the exemplary embodiment includes, when the level of driving attention of the driver is changed after the guiding the driver S120, a step S150 of updating the autonomous driving level to update the autonomous driving level required according to the changed level of driving attention.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A driver management system comprising:
a monitoring part configured to determine a level of driving attention of a driver of a vehicle; and
a driving guide part configured to receive the level of driving attention from the monitoring part, determine a level of necessary attention required according to an autonomous driving level of the vehicle, and provide the driver with information on the level of necessary attention such that the level of driving attention satisfies the level of necessary attention.

2. The driver management system of claim 1, wherein the monitoring part collects status information on a state of the vehicle or the driver through a sensor provided in or on the vehicle, and determines the level of driving attention of the driver through the status information.

3. The driver management system of claim 2, wherein the sensor comprises a camera, a biometric sensor, a sound sensor, a motion sensor, or a contact sensor, and is operated toward the vehicle or the driver from a position inside or outside the vehicle.

4. The driver management system of claim 2, wherein the status information comprises a driver's gaze, whether a driver's hand is positioned on a steering wheel, or a driver's seat position.

5. The driver management system of claim 4, wherein the monitoring part determines that the level of driving attention of the driver is high when the driver's gaze is directed forward, or when the driver's hand is positioned on the steering wheel, or when the driver's seat position is close to acceleration and deceleration devices of the vehicle, and determines that the level of driving attention of the driver is low when the driver's gaze is directed from a front to another points, or when the driver's hand is not positioned on the steering wheel, or when the driver's seat position is not close to the acceleration and deceleration devices of the vehicle.

6. The driver management system of claim 1, further comprising:
an autonomous driving part configured to control an autonomous driving function of the vehicle, wherein the autonomous driving part is configured to receive the level of driving attention and the level of necessary attention from the monitoring part and the driving guide part, respectively.

7. The driver management system of claim 6, wherein the autonomous driving part is configured to perform the autonomous driving function of the vehicle according to a required autonomous driving level when the level of driving attention of the driver satisfies the level of necessary attention required according to the required autonomous driving level.

8. The driver management system of claim 6, wherein the driving guide part is configured to warn the driver or reinform the driver with the information on the level of necessary attention when the level of driving attention of the driver does not satisfy the level of necessary attention required according to the required autonomous driving level.

9. The driver management system of claim 8, wherein the driving guide part is configured to warn the driver or reinform the driver with the information on the level of necessary attention in a manner including a warning light, a voice, or a display inside the vehicle.

10. The driver management system of claim 1, wherein, when the level of driving attention of the driver is changed, the driving guide part updates the autonomous driving level required according to the changed level of driving attention.

11. The driver management system of claim 1, wherein the monitoring part collects status information via the sensor by way of wired or wireless communications between the monitoring part and the sensor.

12. A method of operating a driver management system, the method comprising:
monitoring a driver of a vehicle to determine a level of driving attention of the driver;
determining a level of necessary attention required according to a required autonomous driving level; and
assisting the driver by providing information on the level of necessary attention to the driver such that the level of driving attention determined in the monitoring of the level of driving attention of the driver satisfies the level of necessary attention.

13. The method of claim 12, further comprising:
after the assisting the driver, performing an autonomous driving function of the vehicle, wherein the autonomous driving function of the vehicle according to the required autonomous driving level is performed when the level of driving attention determined in the monitoring of the level of driving attention of the driver satisfies the level of necessary attention.

14. The method of claim 12, further comprising:
after the assisting the driver, reinforming the driver, wherein the driver is warned or reinformed with the information on the level of necessary attention when the level of driving attention determined in the monitoring of the level of driving attention of the driver does not satisfy the level of necessary attention.

15. The method of claim 12, further comprising:
when the level of driving attention of the driver is changed after the guiding the driver, updating the autonomous driving level to update the autonomous driving level required according to the changed level of driving attention.

16. The method of claim 12, wherein monitoring a level of driving attention of a driver comprises:
sensing, via a sensor provided in or on the vehicle, a state of a driver of the vehicle based on sensed data obtained by the sensor, and
determining a current level of driving attention of the driver based on the sensed data.

17. A non-transitory computer readable program medium comprising program code, that when executed by at least one processor, cause the at least one processor to perform operations comprising:
receiving, from a sensor provided in or on a vehicle, monitoring information of a driver of the vehicle to determine a level of driving attention of the driver;
determining a level of necessary attention required according to a required autonomous driving level; and
assisting the driver by providing information on the level of necessary attention to the driver such that the level of driving attention determined in the monitoring of the level of driving attention of the driver satisfies the level of necessary attention.

18. The non-transitory computer readable program medium of claim 17, wherein the program code, when executed by the at least one processor, further causes the at least one processor to perform operations comprising:
after the assisting the driver, performing an autonomous driving function of the vehicle, wherein the autonomous driving function of the vehicle according to the required autonomous driving level is performed when the level of driving attention determined in the monitoring of the level of driving attention of the driver satisfies the level of necessary attention.

19. The non-transitory computer readable program medium of claim 17, wherein the program code, when executed by the at least one processor, further causes the at least one processor to perform operations comprising:
after the assisting the driver, reinforming the driver, wherein the driver is warned or reinformed with the information on the level of necessary attention when the level of driving attention determined in the monitoring of the level of driving attention of the driver does not satisfy the level of necessary attention.

20. The non-transitory computer readable program medium of claim 17, wherein the program code, when executed by the at least one processor, further causes the at least one processor to perform operations comprising:
when the level of driving attention of the driver is changed after the guiding the driver, updating the autonomous driving level to update the autonomous driving level required according to the changed level of driving attention.
